(19) United States
(12) Patent Application Publication
(10) Pub. No.: US 2009/0059759 A1
(43) Pub. Date: Mar. 5, 2009

(54) TRANSMISSIVE OPTICAL RECORDING MEDIUM, HOLOGRAM RECORDING DEVICE AND HOLOGRAM RECORDING METHOD

(75) Inventors: Hisae Yoshizawa, Kanagawa (JP); Katsunori Kawano, Minamiashigara-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/108,603

(22) Filed: Apr. 24, 2008

(30) Foreign Application Priority Data
Sep. 5, 2007 (JP) 2007-230745

(51) Int. Cl. G11B 7/00

(52) U.S. Cl. 369/94; 369/103

(57) ABSTRACT

A transmissive optical recording medium includes: a first recording layer including a recording material capable of fixing record of information; a second recording layer including a recording material capable of fixing record of information; and a polarizing plate between the first recording layer and the second recording layer.

### CROSS-REFERENCE TO RELATED APPLICATION

This application is based on and claims priority under 35 USC §119 from Japanese Patent Application No. 2007-230745 filed Sep. 5, 2007.

### BACKGROUND

(i) Technical Field

The present invention relates to a transmissive optical recording medium and a hologram recording device and a hologram recording method for recording a hologram in the transmissive optical recording medium.

(ii) Related Art

In a usual optical disk such as a CD(a compact disk) or a DVD (a digital versatile disk), data is recorded in the plane direction of the disk in bits. Therefore, a surface recording density is enhanced by using a laser having a short wavelength to increase a capacity.

On the contrary, data in a hologram recording is not recorded in bits, and two dimensionally arranged digital information is treated as page data. Further, the data is recorded as a volume hologram due to interference fringes of a laser beam so that a recording capacity can be increased and a high-speed data transfer can be realized.

### SUMMARY

According to an aspect of the invention, there is provided a transmissive optical recording medium including:

a first recording layer including a recording material capable of fixing record of information;

a second recording layer including a recording material capable of fixing record of information; and

a polarizing plate between the first recording layer and the second recording layer.

### BRIEF DESCRIPTION OF THE DRAWINGS

Embodiments of the present invention will be described in detail based on the following figures, wherein:

FIG. 1 is a partly sectional view of a transmissive optical recording medium according to an exemplary embodiment of the present invention;

FIG. 2 is a partly sectional view of a transmissive optical recording medium according to another exemplary embodiment of the present invention;

FIG. 3 is a diagram showing an exemplary embodiment of a hologram recording and reading device for recording or reading a hologram in the transmissive optical recording medium shown in FIG. 1 or FIG. 2; and

FIG. 4 is a diagram showing a display pattern of a spatial light modulator,

wherein description of some reference numerals and signs are set forth below.

10 transmissive optical recording medium

12 first recording layer

14 second recording layer

16 light polarizing plate

18, 20 protecting layer

22 filter

24 light source

26, 28 lens

30 polarizer

32 λ/2 plate

34 spatial light modulator

36 polarized light converting part

38 Fourier transform lens

40 transmissive optical recording medium

42 focal position control part

44 inverse Fourier transform lens

46 photo-detector

48 information obtaining part

### DETAILED DESCRIPTION

Exemplary embodiments of the present invention will be described with reference to the accompanying drawings.

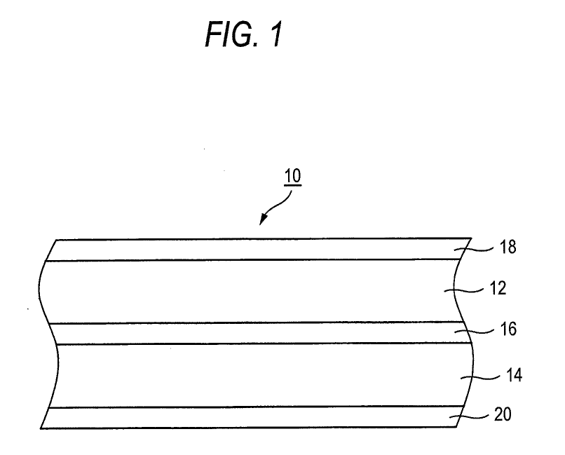

FIG. 1 shows a partly sectional view of a transmissive optical recording medium according to an exemplary embodiment of the present invention. In FIG. 1, the transmissive optical recording medium 10 has a structure in which a first recording layer 12 and a second recording layer 14 are formed from a recording material such as photo-polymer and can record information, and a light polarizing plate 16 are arranged between the first recording layer 12 and the second recording layer 14.

As the photo-polymer, a photo-polymer for a volume recording disclosed in Japanese Patent No. 2849021 can be used. This material can fix the record of information (i.e., record information) and does not have an anisotropy and does not become high in photo-sensitivity (absorption coefficient) only to a linearly polarized light having a specific vibrating direction. Accordingly, even when any light is irradiated to the photo-polymer, the photo-polymer shows substantially the same photo-sensitivity and can record a similar hologram.

Further, the light polarizing plate 16 is designed so as to transmit only the linearly polarized light of a specific polarization angle. A light polarizing plate ordinarily called a light polarizing filter can be used.

Further, in each of the first recording layer 12 and the second recording layer 14, protecting layers 18 or 20 are respectively stacked on a surface opposite to a surface coming into contact with the light polarizing plate 16. The protecting layers 18 and 20 are formed from a transparent material such as glass, poly-carbonate, or the like and function as the protecting layers for the photo-polymer.

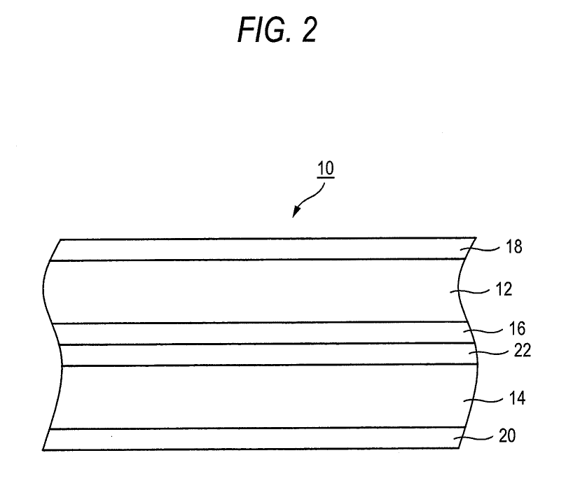

FIG. 2 shows a partly sectional view of a transmissive optical recording medium according to another exemplary embodiment of the present invention. The same members as those of FIG. 1 are designated by the same reference numerals ands an explanation thereof will be omitted. In FIG. 2, a characteristic point resides in that a filter 22 for reducing a quantity of transmission of a light having a specific wavelength is provided between a first recording layer 12 and a second recording layer 14. An order of stacking a light polarizing plate 16 and the filter 22 is not limited to a specific order.

The transmissive optical recording media shown in FIGS. 1 and 2 are used in the case where holograms are recorded by a system that recording light (including signal light and reference light) is irradiated to the optical recording medium from the same direction to record a plurality of data in the thickness direction of the optical recording medium as transmissive holograms (data is recorded at a plurality of positions in the thickness direction).

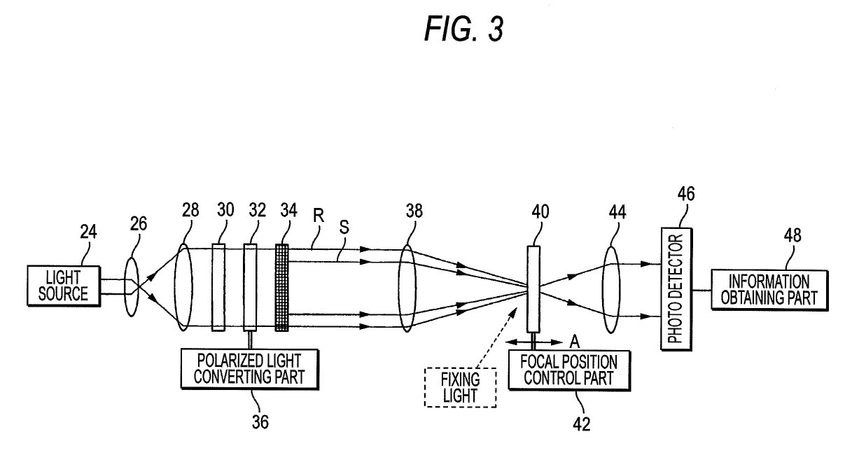

FIG. 3 shows an exemplary embodiment of a hologram recording and reading device for recording or reading (or reproducing) a hologram on the transmissive optical recording medium shown in FIG. 1 or FIG. 2. In FIG. 3, in a case where signal light is recorded as a hologram, coherent light from a light source 24 for generating a laser beam is converted to collimated light rays having a wide diameter by lenses 26 and 28 and made to be incident on a spatial light modulator 34 through a polarizer 30 and a λ/2 plate 32. In this embodiment, the polarizer 30 and the spatial light modulator 34 correspond to a polarized light generating unit.

The polarizer 30 generates the linearly polarized light from the collimated light rays and the λ/2 plate 32 converts the vibrating direction of the linearly polarized light generated by the polarizer 30. Specifically, a first polarized light that does not pass the light polarizing plate 16 of the transmissive optical recording medium shown in FIG. 1 or FIG. 2 is converted to a second polarized light that passes the light polarizing plate 16. When the linearly polarized light passes the λ/2 plate 32, an angle formed by an optical axis thereof and the vibrating direction of an outputted linearly polarized light is theoretically two times as large as an angle formed by the optical axis and the vibrating direction of an incident linearly polarized light. Accordingly, the first polarized light and the second polarized light can be converted by rotating the λ/2 plate 32 by an angle on the optical axis of a signal light S and controlling the angle formed by the optical axis and the vibrating direction of the incident linearly polarized light. The rotation of the λ/2 plate 32 is controlled by a polarized light converting part 36.

The polarized light converting part 36 may be adapted to rotate the polarizer 30 to convert the vibrating direction of the linearly polarized light generated in the polarizer 30.

The spatial light modulator 34 includes a liquid crystal panel to display a digital image (a binary image) having binary digital data “0, 1” set to, for instance, “bright, dark” by a computer that is not shown in the drawing. Thus, the intensity of the light passing the spatial light modulator 34 is modulated in accordance with values of pixels of the binary image to become the signal light S. As described above, since the first polarized light or the second polarized light having vibrating directions is made to be incident in the spatial light modulator 34 through the polarizer 30 and the λ/2 plate 32, the generated signal light S is also polarized. This signal light S is Fourier transformed by a Fourier transform lens 38 and irradiated to the transmissive optical recording medium 40 having the structure shown in FIG. 1 or FIG. 2 from the side of the first recording layer 12.

An order of arranging the spatial light modulator 34 and the polarizer 30 is not limited to an embodiment shown in FIG. 3 and the spatial light modulator 34 may be arranged nearer to the light source 24 than to the polarizer 30.

Further, the reference light R has a common optical axis to the signal light S and is irradiated to the transmissive optical recording medium 40 from the outside of the signal light S. As for the reference light R, coherent light from the light source 24 is converted to collimated light rays by the lenses 26 and 28, and the collimated light rays are made to pass the polarizer 30 and the λ/2 plate 32 and to be incident in an outer peripheral area of the spatial light modulator 34.

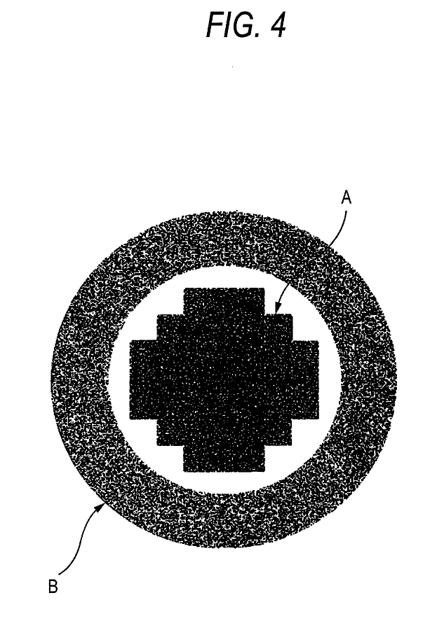

FIG. 4 shows a display pattern of the spatial light modulator 34. In FIG. 4, in a central area A, the binary image for generating the signal light S is displayed. To an outer peripheral area B, the reference light R is transmitted.

The reference light R passing the outer peripheral area of the spatial light modulator 34 is Fourier transformed by the Fourier transform lens 38 and irradiated to the transmissive optical recording medium 40 in a similar manner to the signal light S.

In the embodiment shown in FIG. 3, a focal position control part 42 holds the transmissive optical recording medium 40 and moves the optical recording medium 40 in the direction of an optical axis (a direction shown by an arrow mark A in the figure) to adjust a distance between the transmissive optical recording medium 40 and the Fourier transform lens 38. Thus, a focal position, at which the first polarized light or the second polarized light are focused in the transmissive optical recording medium 40, can be controlled. In this case, the focal position is determined depending on the first polarized light and the second polarized light. Namely, when the first polarized light or the second polarized light is irradiated to the transmissive optical recording medium 40 from the side of the first recording layer 12, the first polarized light that does not pass the light polarizing plate 16 is focused on a previously set position of the first recording layer 12 in the thickness direction shown FIG. 1 or FIG. 2. Thus, in recording the hologram in the first recording layer 12, since the first polarized light is shielded by the light polarizing plate 16 and does not reach the second recording layer 14, an unnecessary exposure can be avoided from arising in the second recording layer 14. Further, the second polarized light passing the light polarizing plate 16 is focused on a previously set position of the second recording layer 14 in the thickness direction shown in FIG. 1 or FIG. 2. When the hologram is completely recorded in the first recording layer 12 before the second recording layer 14 is exposed and the photo-polymer is fixed by a suitable fixing light, if the hologram is recorded on the second recording layer 14, an unnecessary exposure can be avoided from arising in the first recording layer 12.

In accordance with the above-described processes, the signal light S and the reference light R that are Fourier transformed interfere with each other in the first recording layer 12 and the second recording layer 14 of the transmissive optical recording medium 40 so that the signal light S can be recorded in the plurality of positions in the thickness direction as a holograms.

In a fixing process of the first recording layer 12 (i.e., fixing the hologram in the layer), the reference light R may be irradiated or light from a light source different from the light source 24, such as an LED (a light emitting diode), may be irradiated. In a case where the reference light R is irradiated, in order to avoid the unnecessary exposure from arising in the second recording layer 14, the reference light R is made to be the first polarized light that does not pass the light polarizing plate 16. Further, in a case where the different light source is used, for instance, as shown by a broken line in FIG. 3, a light may be irradiated to the transmissive optical recording medium 40 from a separate optical path from those of the signal light S and the reference light R. Further, if light having a different wavelength (specific wavelength) from that of the light used for recording is used as fixing light and the filter 22 that does not pass the light of the specific wavelength is provided as shown in FIG. 2 to interrupt the fixing light of the first recording layer 12, then the unnecessary exposure can be avoided from arising in the second recording layer 14 during the fixing process of the first recording layer 12.

In this embodiment, the filter 22 may not is used. For instance, as described above, when the fixing process is carried out by the first polarized light that does not pass the light polarizing plate 16 as the fixing light of the first recording layer 12, an undesired exposure of the second recording layer 14 can be avoided. However, the filter 22 is provided so that an inexpensive LED can be used for the fixing process of the first recording layer 12.

Further, in the embodiment shown in FIG. 2, in a case where the light polarizing plate 16 is not used and only the filter 22 is provided, the hologram needs to be recorded in the first recording layer 12 by light having a wavelength to which the second recording layer 14 is not photo-sensitive. Further, the hologram needs to be recorded in the second recording layer 14 by a light having a wavelength that passes the filter 22. Therefore, a plurality of light sources (since coherent light is required, an expensive light source such as a laser is necessary) for recording the holograms are unfavorably required.

In FIG. 3, when information is read (reproduced) from diffracted light of the hologram, only the reference light R is generated from the coherent light of the light source 24 by the spatial light modulator 34, Fourier-transformed by the Fourier transform lens 38 and irradiated to the transmissive optical recording medium 40. In this case, in the spatial light modulator 34 shown in FIG. 4, the signal light S passing the central area A of the display pattern is interrupted and only the reference light R is controlled to pass the outer peripheral area B. Further, the coherent light from the light source 24 is not allowed to pass the polarizer 30 and the λ/2 plate 32 and a non-polarized light can be used. When the coherent light is allowed to pass the polarizer 30 and the λ/2 plate 32 and the polarized light is used for reading information, the polarized light is made to be the second polarized light that passes the light polarizing plate 16.

The diffracted light thus generated from the hologram is transformed to collimated light rays by an inverse Fourier transform lens 44 and the collimated light rays are received by a photo-detector 46. An output signal of the photo-detector 46 receiving the diffracted light is inputted to an information obtaining part 48 realized by a computer or the like to take the information included in the hologram.

The present invention is not limited to the above-described embodiments and various kinds of applications may be made without changing the contents of the description. For instance, in the embodiments of the present invention, a coaxial optical system is described that the signal light and the reference light are applied so that the optical axes of both the light correspond to each other, however, even a two light wave optical system may be used that light is irradiated to an optical recording medium from separate optical paths.

What is claimed is:

1. A transmissive optical recording medium comprising:
a first recording layer including a recording material capable of fixing record of information;
a second recording layer including a recording material capable of fixing record of information; and
a polarizing plate between the first recording layer and the second recording layer.

2. The transmissive optical recording medium according to claim 1, further comprising a filter between the first recording layer and the second recording layer, the filter reducing a quantity of transmission of light having a specific wavelength

3. The transmissive optical recording medium according to claim 1, wherein the recording material of each of the first recording layer and the second recording layer is a photo-polymer, and each of the first recording layer and the second recording layer has a protective layer on an opposite surface thereof to a surface facing to the polarizing plate.

4. A hologram recording device comprising:
a light source that emits coherent light;
a polarized light generating unit that generates linearly polarized light from the light emitted from the light source, the linearly polarized light including a signal component;
a polarization converting unit that converts the linearly polarized light generated to one of a first polarized light and a second polarized light having a vibration direction different from that of the first polarized light;
a focusing unit that focuses the one of the first polarized light and the second polarized light in a transmissive optical recording medium according to claim 1; and
a focal position controlling unit that controls a focal position of the one of the first polarizing light and the second polarizing light so that the focal position is in one of the first recording layer and the second recording layer in accordance with the one of the first polarizing light and the second polarizing light, so as to record the focused light in the transmissive optical recording medium as a transmissive hologram.

5. A hologram recording method comprising:
irradiating a first recording layer of a transmissive optical recording medium according to claim 1 with first signal light and reference light from a side of the optical recording medium having the first recording layer with respect to the polarizing plate, the first signal light being linearly polarized light having a first vibration direction; and
irradiating a second recording layer of the transmissive optical recording medium with second signal light and the reference light from the side of the optical recording medium having the first recording layer with respect to the polarizing plate, the second signal light being linearly polarized light having a second vibration direction different from the first vibration direction.
